(19) United States
(12) Patent Application Publication
(10) Pub. No.: US 2007/0192181 A1
(43) Pub. Date: Aug. 16, 2007

(54) Automatically modifying web pages to integrate advertising without changing UI

(75) Inventor: Ryan Asdourian, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/352,494

(22) Filed: Feb. 10, 2006

(51) Int. Cl. G06Q 30/00

(52) U.S. Cl. 705/14

(57) ABSTRACT

Methods and system are disclosed for customizing web pages without changing user interface (UI) elements. Keywords, texts, or phrases are located within the web pages and correspondingly turned into links to provide new information like rich media advertisements. The physical layout of the web pages remains intact with only visual changes to the keywords, texts, or phrases shown as links.

### CROSS-REFERENCE TO RELATED APPLICATIONS

Not applicable

### STATEMENT REGARDING FEDERALLY SPONSORED RESEARCH OR DEVELOPMENT

Not applicable.

### BACKGROUND

Many web publishers are using advertising as a source of revenue for their web sites. Currently, web publishers have to reserve space or make modifications to their web site's user interface (UI) in order to place advertisements. The problem of modifying a web site is acute when the web publisher initially develops the website and uses nearly all of the available space for some non-revenue reason such as promoting a product or service, or providing information. Later on, when the web publisher wants to use additional space for revenue opportunities, the web publisher has to decide whether to remove some of the information from the website in order to provide space for one or more advertisements. Unfortunately, the very same information that makes the website popular may be impacted if the web publisher subtracts content from the web site.

In other situations, the web publisher may be approached by or may approach advertisers to run advertisements on the website. The web publisher and the advertiser may enter into a revenue-sharing agreement based on various revenue models. Some of these models include a performance-based model where information is recorded when the user clicks the advertisement or accesses the advertiser's website, such as a pay-per-click. Other models may include an impression-based model where the information is recorded when the advertisement is viewed. With either model, information is tracked for a variety of purposes.

The challenge for web publishers, as stated before, is creating or finding enough space for the advertisement in an environment where the website has already been created. The web publisher may not be able to provide all of the information that was intended either from his or her sources or from the advertiser. For example, one can see situations throughout the Internet where a web publisher has crowded the website with so much information that the website loses its effectiveness. Not only does a user becomes confused or disenchanted, but the user may not even notice any advertisement on the web page.

Even if the website is created from the beginning and is in a development stage, the web publisher may not want to devote a significant amount of resources to advertisements—perhaps detracting from the original intention of the website (i.e. the web publisher's information). The web publisher may want to strike a balance between the content that is shown and the amount of advertisements offered. This notion is not only limited to advertisements but may be applicable to other information that the web publisher wants to provide in the website that augments the web publisher's original information.

### SUMMARY

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The disclosure describes, among other things, automatically modifying web pages to integrate advertising without changing user interfaces (UI). This disclosure includes a solution that allows websites to serve advertisements without adding or modifying UI elements in the web page. Web publishers may incorporate advertisements without changing their websites or changing very little in regards to the physical appearance of the website. The incorporation of the advertisements into the website may be performed by the web publisher or by a third-party as part of a service. The various solutions are summarized below.

A method is provided for customizing a website to provide new information that includes receiving keywords to search in a website or a hypertext markup language (HTML) file of the website. The website or the HTML file of the website is scanned to locate the keywords. Upon an identification of the keywords, the website or the HTML file of the website is modified to provide information associated with the located. keywords. A display of the website is provided where the information is accessible.

In another aspect, a method is provided for customizing a website, with UI elements, to provide new content that includes receiving text to locate in a web page. The web page or the HTML file of the web page is searched to locate the text. If the text is located, the text is respectively associated with content. The web page or the HTML file of the web page is changed to provide the content and to maintain the UI elements of the website. A modified web page is provided with the UI elements and the content.

In yet another aspect, a system for incorporating new information into a website without creating new UI elements is provided that includes a web publisher and a service provider. The web publisher operates to provide a website, identify text located in the website, provide access to an HTML file of the website, or provide access to the website. The service provider operates to receive the text, scan the website or the HTML file of the website to locate the text, modify the website or the HTML file of the website when a subset of the text is identified, or provide information when the subset of the text is selected during a display of the website as a web page. The web publisher and the service provider operate to exchange data associated with the text or the website.

### BRIEF DESCRIPTION OF THE SEVERAL VIEWS OF THE DRAWINGS

The present invention is described in detail below with reference to the attached drawing figures, which are incorporated herein by reference, and wherein:

FIG. 1 is an exemplary operating environment suitable for practicing an embodiment of the present invention;

FIG. 2 is a block diagram of an exemplary initial web system suitable for practicing an embodiment of the present invention;

FIG. 3 is a block diagram of an exemplary modified web system suitable for practicing an embodiment of the present invention;

FIG. 4 is a block diagram of an exemplary monitoring and tracking system suitable for practicing an embodiment of the present invention;

FIG. 5 is a flowchart of an exemplary process for incorporating new information into a website without creating new UI elements when implementing an embodiment of the present invention;

FIG. 6 is a flowchart of an exemplary process for customizing a website when implementing an embodiment of the present invention;

FIG. 7 is an exemplary view of a web page initially created by a web publisher; and

FIG. 8 is an exemplary view of a web page modified implementing an embodiment of the present invention.

### DETAILED DESCRIPTION

The present invention will be better understood from the detailed description provided below and from the accompanying drawings of various embodiments of the invention, which describe, for example, automatically modifying web pages to integrate advertising without changing user interfaces (UI). The detailed description and drawings, however, should not be read to limit the invention to the specific embodiments. Rather, these specifics are provided for explanatory purposes that help the invention to be better understood.

Exemplary Operating Environment

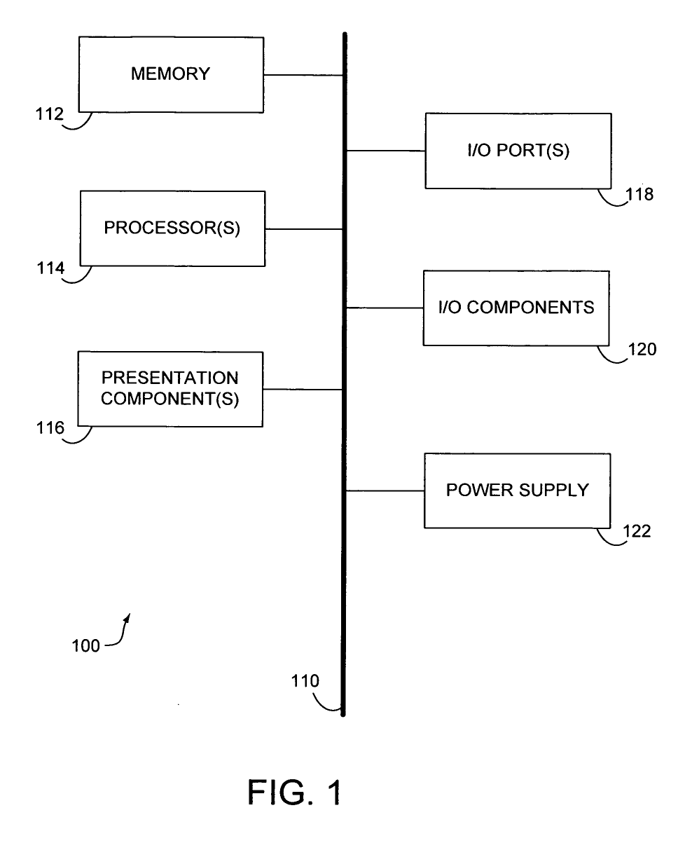

Referring to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device”.

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

Many different arrangements of the various components depicted, as well as components not shown, are possible without departing from the spirit and scope of the present invention. Embodiments of the present invention will be described with the intent to be illustrative rather than restrictive. Alternative embodiments will become apparent to those skilled in the art that do not depart from its scope. A skilled artisan may develop alternative means of implementing improvements without departing from the scope of the present invention.

To help explain the invention without obscuring its functionality, an embodiment will now be referenced in connection with a computing network. Although the present invention can be employed in connection with a computing-network environment, it should not be construed as limited to the exemplary applications provided here for illustrative purposes.

Modifying Web Pages to Integrate Advertising

The development of a mechanism as described in this disclosure allows web publishers to use an ad serving platform to automatically place advertisements in the already-created space of their websites. This enables the web publisher to be part of a profit sharing program that does not require additional space on their original website by adding unwanted content.

The platform enables text to change into links with little or no work by the web publisher. Being that advertisements have become commonplace in web pages, an embodiment of the present invention allows advertisements to be inserted into the web page without changing the layout of the page.

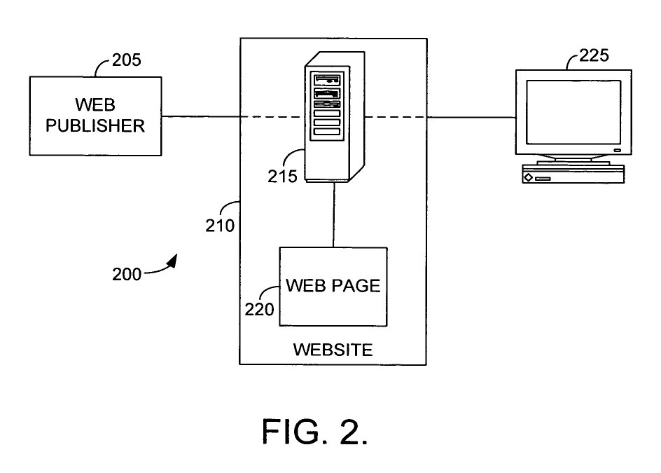

In FIG. 2, an exemplary initial web system is shown in 200 with a web publisher 205, a website 210, a web server 215, a web page 220 , and a user 225. Web publisher 205 creates content identified by web page 220 and places it on web server 215. Although not shown, web page 220 may be created in the form of an HTML file which executes on web server 215.

Web server 215 and web page 220 are identified as website 210. In this disclosure, website 210 and web page 220 may be used interchangeably in an attempt to explain the present invention. Throughout the use of the Internet or other packet network, user 225 may access web page 220 at website 210. However, statements in this disclosure may refer to user 225 as accessing website 210 or accessing web page 220. User 225 may be identified as a person at a computing device with network access.

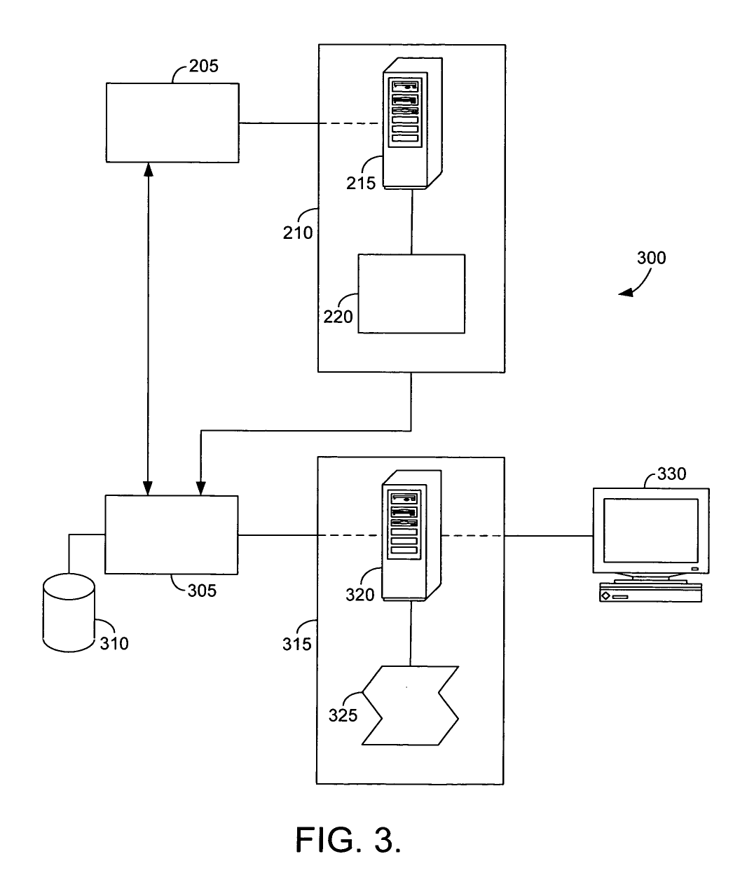

Turning now to FIG. 3, an exemplary modified web system is shown in 300 with web publisher 205, website 210, web server 215, web page 220, a service provider 305, a storage device 310, a modified website 315, a web server 320, a modified web page 325, and a user 330. FIG. 3 is an exemplary illustration of what happens when an implementation of an embodiment of the present invention occurs to the implementation of FIG. 2. The implementation shown in FIG. 3 is not the only embodiment that may be created. FIG. 3 illustrates a transition from FIG. 2.

In contrast to FIG. 2, FIG. 3 shows several inputs leading into service provider 305. These inputs may be characterized as activities of web publisher 205 sending a set of keywords to service provider 305 and providing access to website 210. In order for service provider 305 to modify website 210 to provide additional information at website 325, service provider 305 needs to gather information from web publisher 205. In this case, the information may be the set of keywords associated with the information that is to be added to website 220. In one embodiment, this information may be a set of keywords associated with advertisements.

When service provider 305 obtains the set of keywords, the keywords and other information may be stored in storage device 310. Although only one diagram of storage device 310 is shown, storage device 310 may represent several storage devices including databases, memories, etc.

Service provider 305 may want to access website 210 or receive data related to web page 220 to search for keywords in web page 220. If service provider accesses website 210, service provider may scan web page 220 to identify the location of the keywords that were provided by web publisher 205. If service provider 305 receives data relating to web page 220, the same scanning process can occur. The scanning process may occur by searching the HTML file associated with web page 220. However, other scanning techniques may be employed such as searching the physical rendition of web page 220 and not the underlying HTML file.

If a keyword is located, service provider 305 may receive the HTML file and begin a process of modifying the HTML file to incorporate additional information (in this case an advertisement) into the HTML file. Service provider 305 may consider a variety of issues in determining what advertisements are appropriate for web publisher 205. For example, web publisher 205 may dictate the type of advertisements that are to appear on the website. Web publisher 205 may determine how many advertisements can occur at the website. Web publisher 205 may limit the number of keywords to be modified on a given page of the website. Through the communications between web publisher 205 and service provider 305, these items may be discussed and used as inputs into creating a new website for web publisher 205. Alternatively, service provider 305 may have a set of guidelines or policies that are used to implement changes to the website. For example, service provider 305 may prohibit the use of explicit language, information promoting illegal activities, or information that may impact service provider's ability to conduct business.

Once service provider 305 modifies the HTML file associated with website 210, the modified website may be provided to web server 320 as modified web page 325. Because of the manner of the illustration, modified website 315 could be a modified version of website 210 or a new separate entity. Likewise, web server 320 could be web server 215 or a different server.

Several aspects are now going to be discussed relating to modified web page 325. In implementing an embodiment of the present invention, service provider 305 has a flexibility of incorporating new information into the website. One of the challenges that service provider 305 may need to overcome is to maintain the original UI elements of web page 220 while incorporating the new information. Although the HTML file may be modified, it is preferable to keep the original layout of web page 220 so as not to sacrifice any of the original content. Service provider 305 may accomplish this by converting the located keywords into links. Rather than occupying space on the web page, a user may access the links in a variety of ways. First, a user, such as user 330, may click with a mouse pointer the keyword that has been converted into a link. This action may take the user to another web page containing the new information. Another alternative may be implemented where the link may be accessed when the mouse pointer hovers or rolls over the keyword. This implementation may be achieved using Asynchronous JavaScript and XML (AJAX) or other web methods that enable a rich media experience. This action may be followed by a pop-up window containing the new information.

There are various other possibilities that may be implemented to accomplish providing new information. The commonality of the various approaches is a way to maintain the original UI elements when space is limited or non-existent for new information. And as an option of implementing various embodiments, the implementer could eventually choose to manipulate the physical layout of the web page as desired while still implementing the present invention.

Although FIG. 3 shows service provider 305 as the entity that modifies website 210 and provides modified web site 315, another embodiment may be implemented without service provider 305. In this embodiment, web publisher 205 may modify its own website and provide the output in the form of modified website 315. In this case, web provider 205 would step into the role of service provider 305 to provide the services of customizing website 220, providing the new information such as advertisements, and creating modified website 315.

A scenario may now be discussed that further illustrates the present invention as described in FIGS. 2 and 3. A web server such as web server 215 exists with webpage 220. The data in web page 220 is served to user 225 through the hypertext transfer protocol (HTTP). Now, web publisher 205 wants to provide advertising on web page 220 at website 210 to increase user access and build revenue. Web publisher 205 may use an ad serving protocol from service provider 305 to modify website 210 to provide advertisements. An example of service provider 305 might be MSN® adCenter of Microsoft Corporation of Redmond, Wash.

In continuing with the scenario, the ad serving protocol may receive extracted data from the HTML file of web page 220. The ad serving protocol enables the communication between service provider 305 and web server 215. The ad serving protocol may execute software in web server 215 to generate and extract contents. Service provider 305 examines this data by searching for products or services associated with advertisements in service provider 305's inventory. For example, on a website that reviews digital cameras, the phrase “SLR-TX”might be flagged. Service provider 305 may now connect this phrase with an advertisement and modify the HTML file to allow the phrase to be a clickable link. The format of such a link is another matter discussed below which may be implemented in various ways.

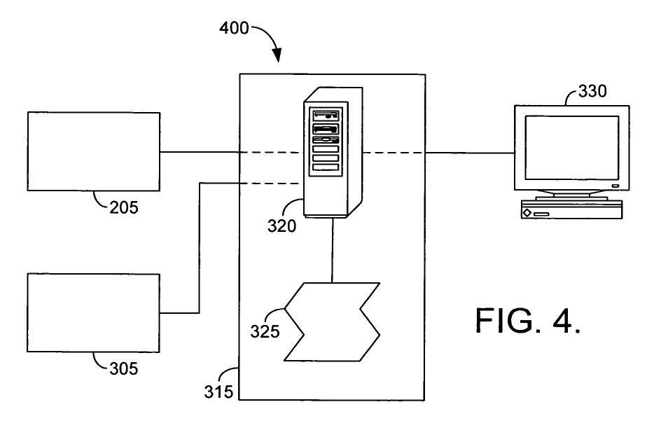

In FIG. 4, an exemplary monitoring and tracking system is shown in 400. FIG. 4 illustrates a situation where web publisher 205 and service provider 305 have access to website 315. This situation may occur when a revenue relationship exists whereby service provider 305 provides information in the form of advertisements which may be paid for by a third party. Web publisher 205 is interested in receiving revenue from users, like user 330, who visit website 315. So, web publisher 205 may have a responsibility for maintaining the operation of website 315. At the same time, service provider 305 is interested in tracking data related to the advertisement. Although service provider 305 provided the advertisement from its inventory to create modified web page 325, service provider 305 may have received the advertisement or the authority for providing the advertisement from the third party. Through the relationship between service provider 305 and the third party, there may exist various qualifications as to how the advertisement is shown, when the advertisement is shown, and where the advertisement may be shown. Consequently, FIG. 4 illustrates the relationships that may extend beyond the types of relationships discussed between web publisher 205 and service provider 305 in FIGS. 2 and 3.

In continuing the scenario discussed above, the advertisement link may contain tracking data that is activated if clicked so that impressions, such as click rate, and other data pertaining to the advertisement may be tracked. When the link is clicked, the data that is sent may also include the referring website so that web publisher 205 may receive credit for the click and receive an incentive or pre-arranged compensation. As discussed above, the mechanism for tracking data may take the form of an impression-based model or a performance-based model. Either model aids web publisher 205 and service provider 305 in forming a profit sharing program.

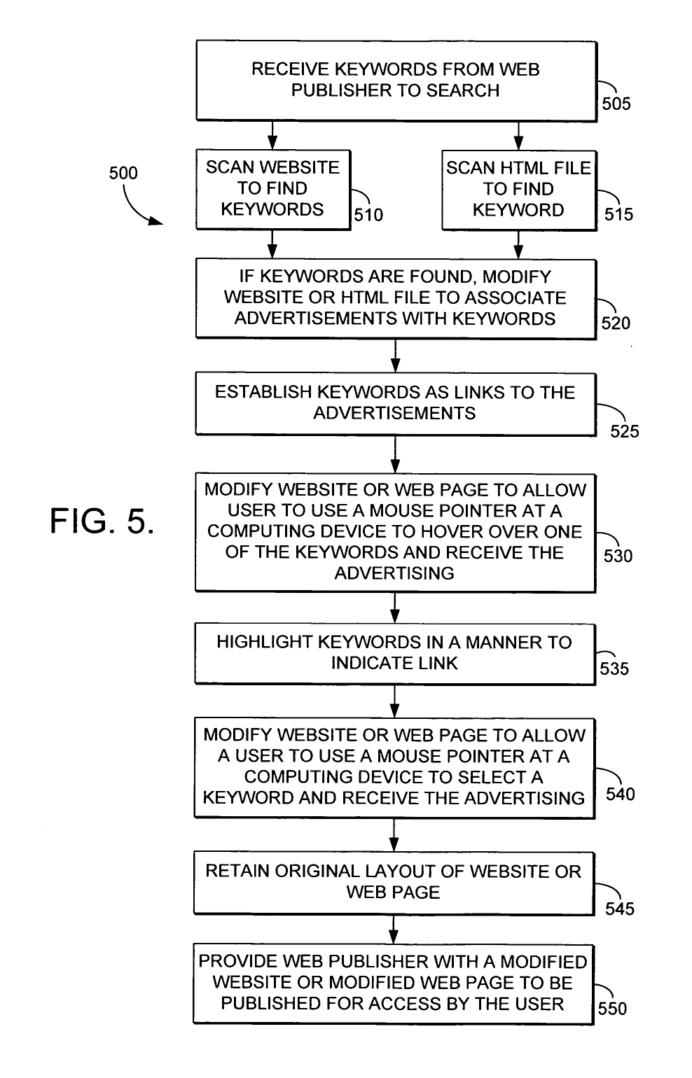

Turning now to FIG. 5, a process for incorporating new information into a website without creating new UI elements is shown in a method 500. In a step 505, service provider 305 receives keywords from web publisher 205 to search in web page 220. Service provider 305 may either scan website 210 to find the keywords (step 510) or scan the HTML file of web page 220 to find the keywords (step 515).

If keywords are found during the scanning activity, service provider 305 modifies website 210 or the HTML file of website 210 to associate advertising material with the keywords in a step 520. In a step 525, service provider 305 establishes the keywords as links to the advertising material. Service provider 305 modifies website 210 or web page 220 to allow user 330 to use a mouse pointer at a computing device to hover over one of the keywords and receive the advertisement, shown in a step 530.

As part of the modification, service provider 305 may arrange the keywords in a manner to provide a visual indication of keywords as links, shown in a step 535. This arrangement may occur in the form of underlining the keyword, bolding the font of the keyword, or literally highlighting the keyword in a color. In a step 540, service provider 305 modifies website 210 or web page 220 to allow user 330 to use a mouse pointer at a computing device to select a keyword and receive the advertisement. User 330 may click on the keyword to either be taken to another web page containing the advertisement, to receive a pop-up window containing the advertisement, or to receive the advertisement in another media form.

In a step 545, service provider 305 and web publisher 205 attempt to retain the original layout of website 210 or web page 220. This retention may minimize the challenges imposed upon web publisher 205 to rearrange or remove content on the web page. When modified web page 325 is available, an updated HTML file is provided to web server 320 at modified website 315. The new web page is provided to web publisher 205 to be published for access by users like user 330.

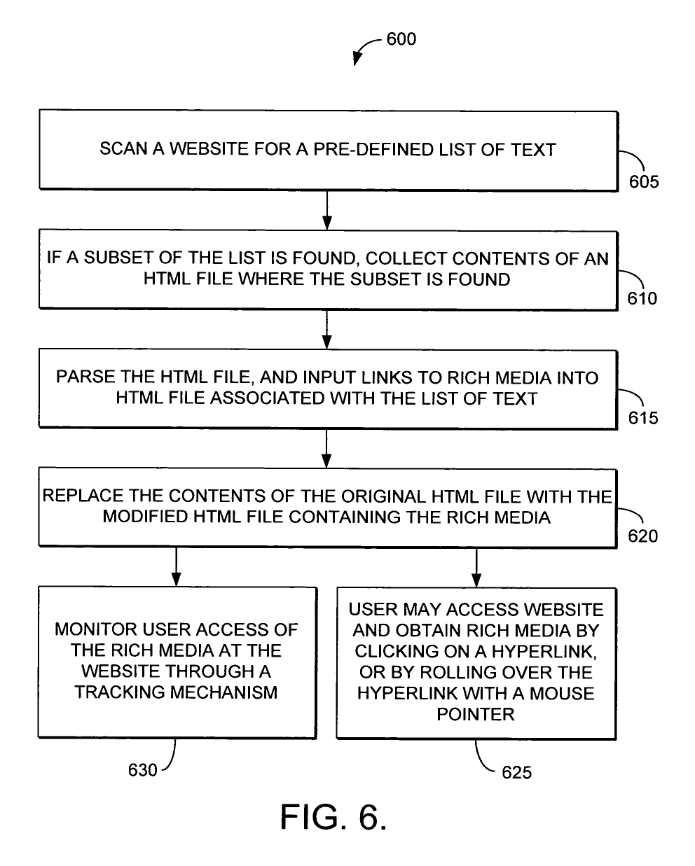

Turning now to FIG. 6, a process for customizing a website is shown in a method 600. The website may be customized by a party in implementing an embodiment of the present invention. Much of the disclosure has discussed the customization efforts of service provider 305. However, web publisher 205 or a third party could customize the website in implementing embodiments of the present invention.

In a step 605, a scan is made of website 210 for a pre-defined list of text. If some of the information in the list is found, the contents of an HTML file is collected when the information is found (a step 610). Alternatively, if a search is made of website 210 or web page 220 and nothing on the list is found then the process stops because there is no need to manipulate web page 220. As an example, a travel company with websites may develop a list of text associated with traveling in one activity and perform the scanning process of various websites (owned by the travel company) in another activity. There may be no correlation between the two activities. The first activity may state in the example “locate occurrences of the text ‘flight’, ‘airline’, ‘airport’, ‘air travel’, or ‘airplane’.” The second activity, which may or may not be performed by the travel company, may scan for the listed text in the website and incorporate advertising associated with air travel such as airline offers, etc. As discussed above, both activities may include some restriction such as having the travel company prohibit the advertising of consolidation air carriers as an example. The idea here is to illustrate the possibilities that may be achieved by an implementer when implementing an embodiment of the present invention.

In a step 615, the collected HTML file is parsed and links to rich media are inserted into the HTML file associated with the list of text. The term rich media is varied and may include text, graphics, audio, video, flash media, or any other media for the user experience.

When the rich media is incorporated into links with web page 220, the contents of the HTML files with the rich media are replaced at the website, now called modified website 315 with modified web page 325 (a step 620). Following the availability of website 315, a user may access modified website 315 and obtain rich media in the form of advertising by clicking on a hyperlink or by rolling over the hyperlink in a step 625. Either action may result in either the user being taken to a new web page to view the advertisement, receiving a pop-up window with the advertisement, or obtaining the advertisement in another form.

Again, with modified web page 325 operating in web server 320, user access of the rich media can be monitored through a tracking mechanism established by the web publisher, service provider, or third party (in a step 630). The tracking mechanism was discussed above and will not be repeated here except to mention that the tracking activity may be related to impression-based modeling, performance-based modeling, or another tracking form.

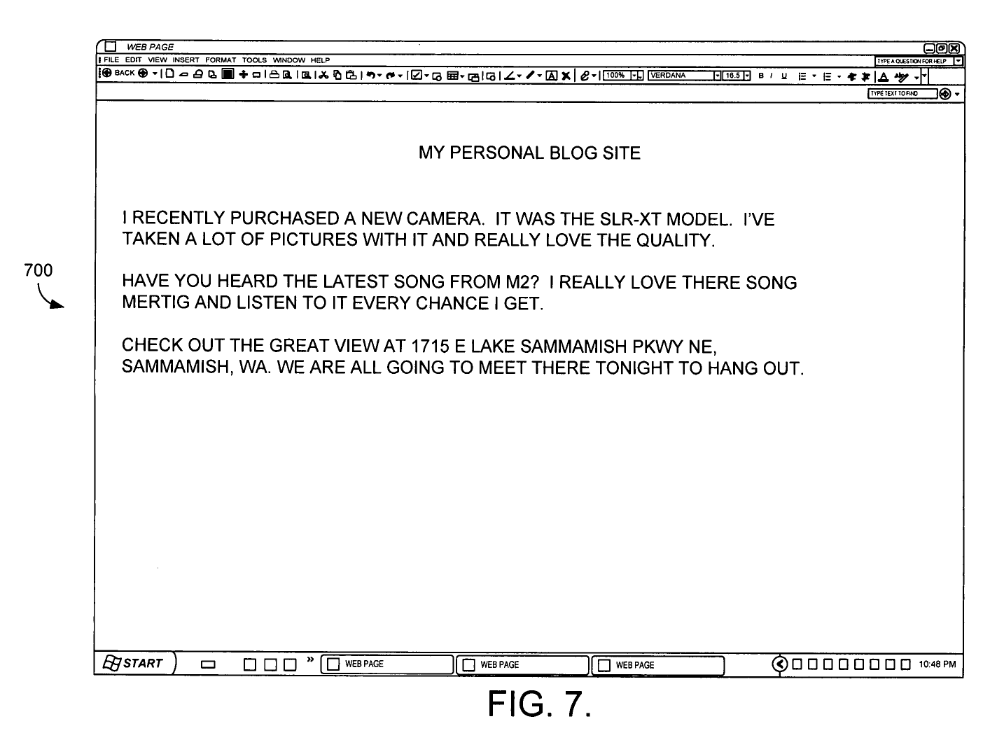

In FIG. 7, a view of a web page initially created by a web publisher is shown in 700. FIG. 7 is indicative of a web page that has been created before the implementation of an embodiment of the present invention. The illustration has been provided in a simplistic view so as not to obscure an understanding of the present invention. As shown in the web page, there are three (3) sentences, each dealing with a different experience. Now, the publisher of the web page may want to enhance the website with additional information but does not want to change the physical layout of the web page.

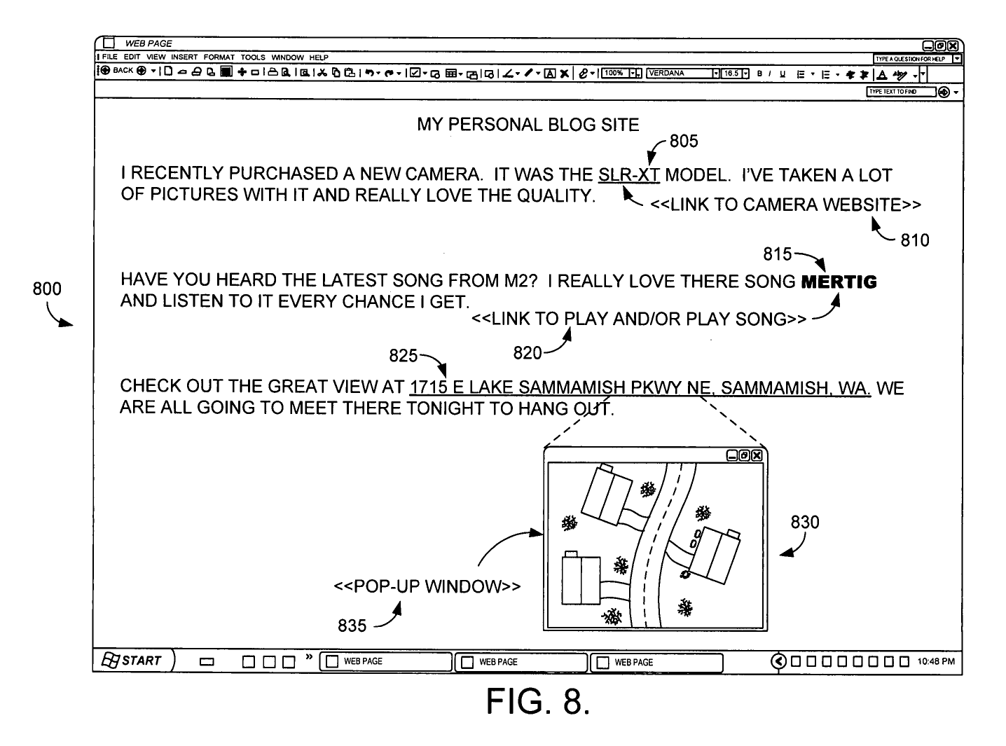

Turning now to FIG. 8, a view of the web page in FIG. 7 has been modified implementing an embodiment of the present invention (800). From the discussion above, the web publisher identified some keywords or phrases to be located in the web page. In this case, those keywords or phrases were “SLR-XT” (805), “Mertig” (815), and “1715 E Lake Sammamish Pky NE, Sammamish, WA” (825). The modifier of the website or web page took those keywords and phrases and scanned for them in the original web page shown in FIG. 7. The web page was then modified to add links to result in the web page shown in FIG. 8. Some additional information is provided in FIG. 8 for clarity and will be discussed below.

In 805, the keyword SLR-XT becomes a link to information relating to a new camera. This link may lead to another web page and may include advertising, product information, etc. As shown in FIG. 8, the modifier of the web page has indicated 805 as a link by underlining the text SLR-XT. However, the modifier could have chosen another alternative for identifying the link. Referring to the link, notation 810 shows that SLR-XT 805 is a link to a camera website. The notation is provided for clarity and is not part of the implemented embodiment.

In 815, the keyword Mertig becomes a link to information relating to a song by the group M2. By clicking this link, the user may hear a song or may have an opportunity to purchase the song. Contrast to 805, Mertig 815 is provided in bold font indicating the flexibility of how information may be presented to the user, like user 330. Again, notation 820 shows that Mertig 815 is a link to play a song and would normally not appear in the embodiment.

In 825, the phrase “1715 E Lake Sammamish Pky NE, Sammamish, WA”becomes a link to a photograph or another web page (830). For illustrative purposes here, rather than click on the link, user 330 may use a mouse pointer to roll over or hover over the link to display the photograph 830. As the mouse pointer stops over the phrase, photograph 830 may appear on user 330's display. In FIG. 8, photograph 830 is shown for clarity but would normally not appear until the mouse pointer hovers over the phrase or is clicked by the user. Again, notation 835 is provided to illustrate the origin of photograph 830 and would not appear in the embodiment.

The keywords and phrase described in FIG. 8 illustrated the point of how the physical embodiment may be displayed to a user in implementing embodiments of the present invention. Different implementers or modifiers may incorporate different approaches to provide links to keywords and provide new information to users.

Another scenario may be shown to illustrate implementing embodiments of the present invention using some existing website material. For demonstrative purposes, a website is analyzed that reviews the CANON® DIGITAL EOS REBEL® XT camera of Canon Kabushiki Kaisha Corporation of Tokyo, Japan. The website is located at www.dcresource.com/reviews/canon/digital rebel xt-review/index.shtml and contains an exemplary text that can become links. Besides the use of “Rebel XT”, the phrase “Digital SLR”may be flagged as a link to a retailer or other available digital SLR cameras. At the website, other CANON® models may be compared such as the CANON®EOS-20D. The phrase “EOS-20D” can be turned into a link providing information about the model or connecting to a retailer. With the website, the idea is that a platform may be used to extract the text from the web page to determine what information may be provided such as advertisements.

In implementing an embodiment of the present invention with the current website, the following data may be encountered in the website's HTML file: <p class=“bodytxt”>The chart below compares the two Rebel models plus the EOS-20D, the natural &quot; step up &quot; camera in the family:</p>. This code is an example of what a service provider like MSN® adCenter may work with in order to modify a website. After passing through the service provider using EOS-20D as the keyword, the code may now read as follows: <p class=“bodytxt” >The chart below compares the two Rebel models plus the <a href=http://ads.msn.coml[trackingdata]>EOS-20D</a>, the natural &quot; step up &quot; camera in the family:</p>. The service provider would re-display the HTML file with the incorporated links. In the example above, the user may click on the phrase “EOS-20D” to be taken to an advertisement appearing on another web page. However, the original physical layout of the web page remains unchanged. The discussion above is just one example of the possibilities that may be explored in implementing an embodiment of the present invention.

The prior discussion is for illustrative purposes to convey exemplary embodiments. The steps discussed in FIGS. 5, and 6 may be executed without regards to order. Some steps may be omitted and some steps may be executed at a different time than shown. For example, step 540 may be executed before step 530, and step 630 may be executed before step 610. The point here is to convey that the figures are merely exemplary for the embodiments of the present invention and that other embodiments may be implemented for the present invention. It will be understood that certain features and sub-combinations are of utility and may be employed without reference to other features and sub-combinations and are contemplated within the scope of the claims.

As shown in the above scenarios, the present invention may be implemented in various ways. From the foregoing, it will be appreciated that, although specific embodiments of the invention has been described herein for purposes of illustration, various modifications may be made without deviating from the spirit and scope of the invention. Accordingly, the invention is not limited except as by the appended claims.

The invention claimed is:

1. A method for customizing a website to provide new information, comprising:
receiving one or more keywords to search in at least one of a website or an HTML file of the website;
scanning at least one of the website or the HTML file of the website to locate the one or more keywords;
upon an identification of the one or more keywords, modifying at least one of the website or the HTML file of the website to provide one or more information associated with the located one or more keywords; and
providing for a display of the website wherein the one or more information is accessible.

2. The method of claim 1, wherein modifying the at least one of the website or the HTML file of the website comprises establishing one or more links respectively at the located one or more keywords wherein selecting a keyword in a web page executes a link to the one or more information.

3. The method of claim 2, wherein providing for the display comprises providing for an indication of the one or more links in the web page as the located one or more keywords.

4. The method of claim 3, further comprising executing the link wherein a pop-up window appears in a display of the web page with the one or more information.

5. The method of claim 1, wherein the one or more information is selected from a group including an advertisement, a textual display, a graphical display, an audio, and a video.

6. The method of claim 1, further comprising accessing the one or more information by hovering or passing a pointer attached to a computing device over a member of the located one or more keywords shown in a display of a web page.

7. The method of claim 1, further comprising monitoring the website to measure a user access of the one or more information.

8. One or more computer-readable media having instructions stored thereon for performing the method of claim 1.

9. A method for customizing a website, with a set of user interface (UI) elements, to provide new content, comprising:
receiving one or more text to locate in a web page;
searching at least one of the web page or the HTML file of the web page to locate the one or more text;
if the one or more text is located, associating the one or more text respectively with one or more content;
changing at least one of the web page or the HTML file of the web page to provide the one or more content and to maintain the set of UI elements of the website; and
providing a modified web page with the set of UI elements and the one or more content.

10. The method of claim 9, wherein changing the at least one of the web page or the HTML file of the web page comprises establishing one or more links respectively at the located one or more text wherein selecting a text in the web page executes a link to the one or more content.

11. The method of claim 10, wherein providing the modified web page comprises providing an indication of the one or more links in the web page as the located one or more text.

12. The method of claim 11, further comprising executing the link wherein a pop-up window appears in a display of the web page with the one or more content.

13. The method of claim 9, wherein the one or more content is selected from a group including an advertisement, a text, a graph, a picture, an audio, and a video.

14. The method of claim 9, further comprising accessing the one or more content by hovering or passing a pointer attached to a computing device over a member of the located one or more text shown in a display of a web page.

15. The method of claim 9, further comprising monitoring the web page to measure a user access of the one or more content.

16. One or more computer-readable media having instructions stored thereon for performing the method of claim 9.

17. A system for incorporating new information into a website without creating new user interface (UI) elements, comprising:
a web publisher operable to at least one of provide a website, identify a set of text located in the website, provide an access to an HTML file of the website, or provide the access to the website;
a service provider operable to receive the set of text, to scan the website or the HTML file of the website to locate the set of text, to modify the website or the HTML file of the website when a subset of the set of text is identified, or to provide a set of information when the subset of the set of text is selected during a display of the website as a web page; and
the web publisher and the service provider operable to exchange a set of data associated with the set of text or the website.

18. The method of claim 17, wherein the service provider operable to establish a set of links respectively at the located set of text wherein the subset of the set of text in the website provides a link to the set of information.

19. The method of claim 17, further comprising monitoring the website to measure a user access of the set of information.
